(19) United States
(12) Patent Application Publication
(10) Pub. No.: US 2011/0278326 A1
(43) Pub. Date: Nov. 17, 2011

(54) Grease Gun with a Pressure-Relief Device

(76) Inventor: Wen-I GUO, Taiping City (TW)

(21) Appl. No.: 12/780,273

(22) Filed: May 14, 2010

(51) Int. Cl. B05C 17/01; B05C 21/00; B65D 83/76

(52) U.S. Cl. 222/318; 222/333

(57) ABSTRACT

A grease gun with a pressure-relief device comprises a pressure-relief device. When the grease gun is subjected to an excessive driving force, the pressure-relief device will be pressed to allow the valve member of the pressure-relief device to compress the spring toward the cover member, and then the grease-passage port and the cartridge port will communicate with each other, so that the grease can flow back into the grease cartridge to further control the pressure in the grease gun, thus avoiding the damage to the grease gun and further extending the service life of the grease gun.

### BACKGROUND OF THE INVENTION

1. Field of the Invention

The present invention relates to a grease lubricating device; and more particularly to a grease gun with a pressure-relief device.

2. Description of the Prior Art

As shown in FIG. 1, a conventional grease gun X has both ends connected to a grease cartridge A and a power tool B, and the grease is squeezed out by the power tool B. However, the grease gun X is characterized in that it can be connected to different power tools B to improve convenience in use, but since different power tools B may supply different driving forces, when the grease gun X is connected to a power tool B with excessive driving force, the power tool B will apply pressure into the grease gun X, such that the inner parts of the grease gun X will be directly subject to the excessive pressure from the power tool B. As a result, the inner parts of the grease gun X are prone to damaging, thus shortening the service life of the grease gun X.

The present invention has arisen to mitigate and/or obviate the afore-described disadvantages.

### SUMMARY OF THE INVENTION

The primary objective of the present invention is to provide a grease gun with a pressure-relief device which can control the pressure to avoid the damage to the inner parts of the grease gun and extend the service life of the grease gun.

To achieve the above objective, a grease gun with a pressure-relief device in accordance with the present invention comprises:

a housing being defined in a first end thereof with a cartridge accommodation groove for accommodation of a grease cartridge, a connecting portion of a connecting shaft of a transmission mechanism protruding from a second end of the housing for connection to a power tool, the housing being further provided with a grease outlet opposite cartridge accommodation groove, the grease outlet being defined with a grease passage, the grease passage being connected to the cartridge accommodation groove through a communication hole, a valve port being vertically connected to the grease passage in the grease outlet through a grease-passage port, the valve port being further defined with a cartridge port connected to the cartridge accommodation groove; and

a pressure-relief device including a valve member, a spring and a cover member, the valve member including a conical stopping end, the stopping end being inserted into the grease-passage port of the valve port of the housing, the spring being mounted on the valve member, the cover member sealing the valve port of the housing, the spring being normally pressed against the valve member, the stopping end of the valve member sealing the grease-passage port, when being pressed, the valve member will compress the spring toward the cover member to allow the grease-passage port and the cartridge port to communicate with each other.

With the arrangement of the pressure-relief device, the pressure will be applied onto the pressure-relief device to make the valve member of the pressure-relief device compress the spring toward the cover member, after that, the grease-passage port, the valve port and the cartridge port will communicate one another, so that the grease will flow back into the grease cartridge to relieve the excessive pressure in due time and ensure a desired grease feeding or flow rate, thus avoiding the damage to the inner parts of the grease gun while extending the service life of the grease gun.

### BRIEF DESCRIPTION OF THE DRAWINGS

FIG. 1 is a planar view of a conventional grease gun connected with a power tool;

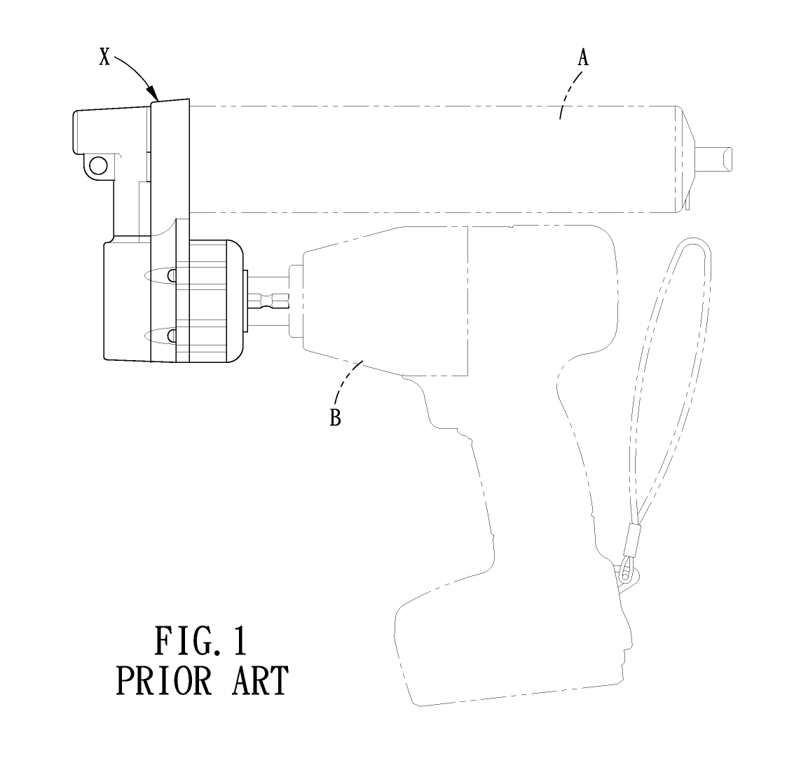

FIG. 2 is an exploded view of a part of a grease gun with a pressure-relief device in accordance with the present invention;

FIG. 3 is an exploded view of another part of the grease gun with a pressure-relief device in accordance with the present invention;

FIG. 4 is a perspective view of the grease gun with a pressure-relief device in accordance with the present invention;

FIG. 5 is an operational view of the grease gun with a pressure-relief device in accordance with the present invention;

FIG. 6 is a partial cross-sectional view of the grease gun with a pressure-relief device in accordance with the present invention; and

FIG. 7 is another partial cross-sectional view of the grease gun with a pressure-relief device in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

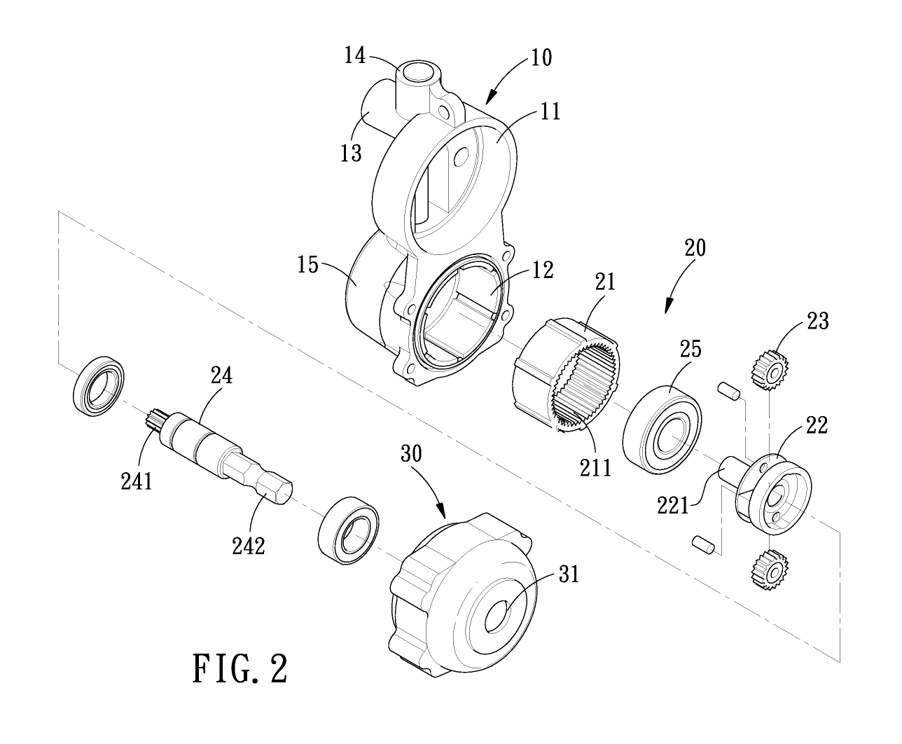

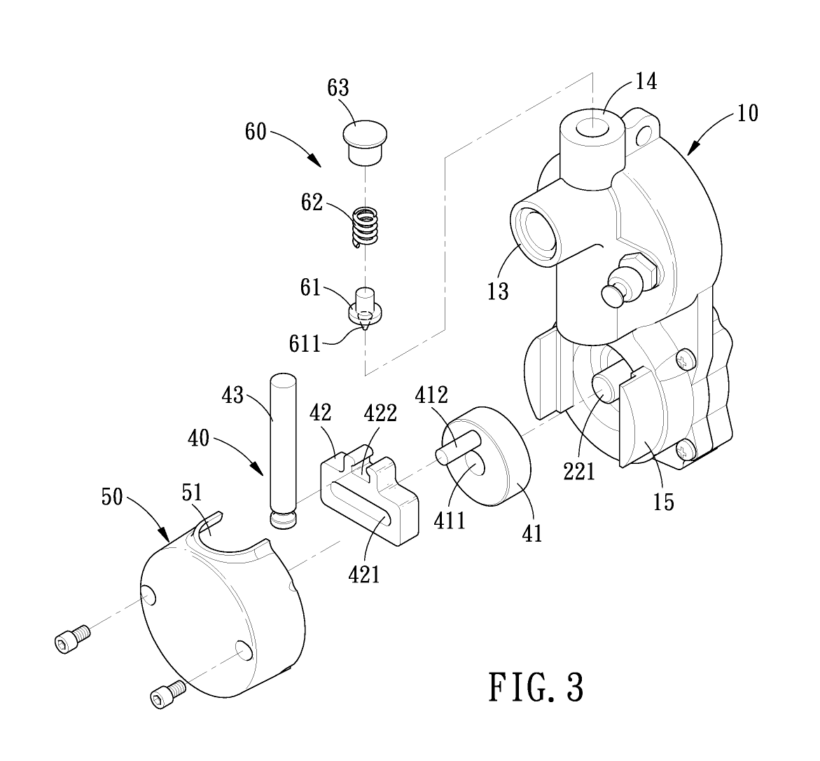

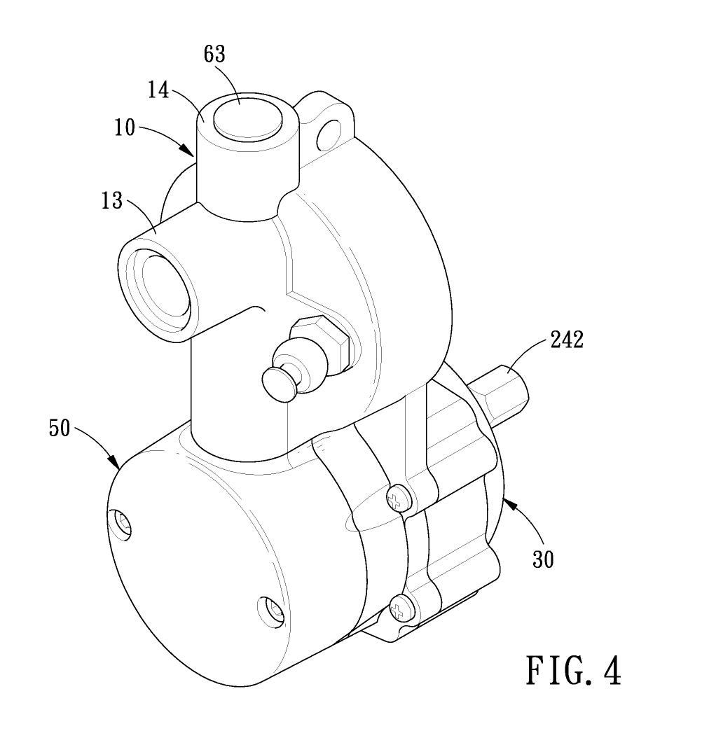

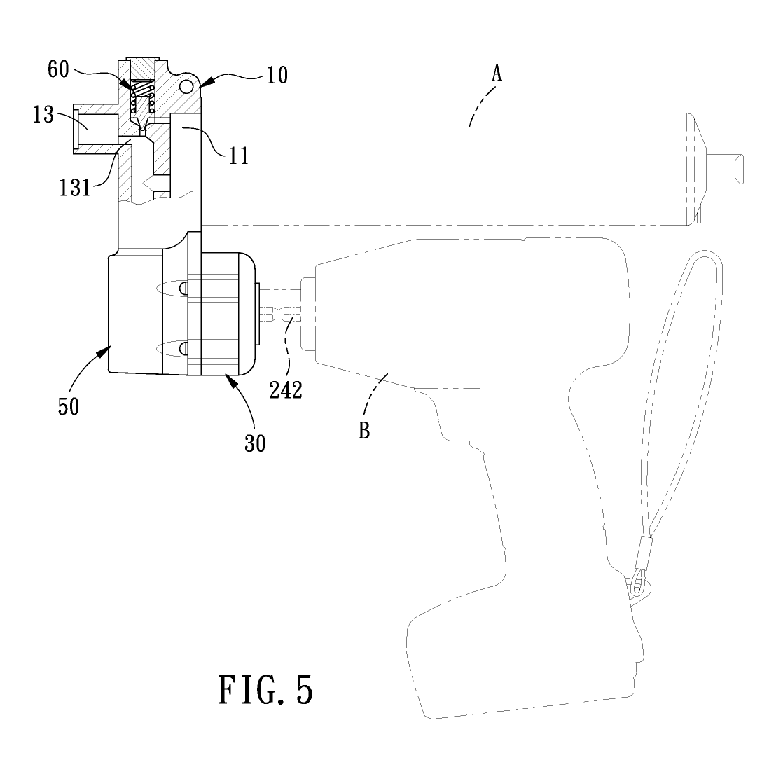

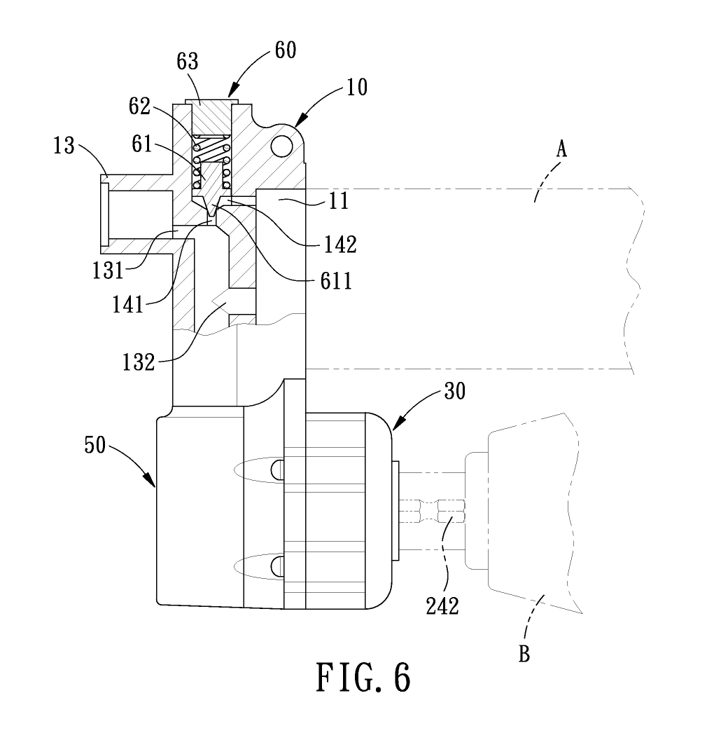

Referring to FIGS. 2-7, a grease gun with a pressure-relief device in accordance with a preferred embodiment of the present invention comprises a housing 10, a transmission mechanism 20, a first cover 30, a linkage mechanism 40, a second cover 50, and a pressure-relief device 60.

The housing 10 is defined with a cartridge accommodation groove 11 in a first end thereof for accommodation of a grease cartridge, and a transmission groove 12 in a second end thereof. The housing 10 is further provided with a grease outlet 13 opposite the cartridge accommodation groove 11, and two guiding portions 15 opposite the transmission groove 12. The grease outlet 13 is defined with a grease passage 131 which is connected to the cartridge accommodation groove 11 through a communication hole 132. A valve port 14 is vertically connected to the grease passage 131 in the grease outlet 13 through a grease-passage port 141. The valve port 14 is further defined with a cartridge port 142 connected to the cartridge accommodation groove 11. The two guiding portions 15 are integrally extended from the housing 10, and opposite surfaces of the two guiding portions 15 are planar.

The transmission mechanism 20 includes an engaging ring 21, a pivoting seat 22, two planetary gears 23, a connecting shaft 24 and plural bearings 25. The engaging ring 21 includes an inner annular tooth portion 211 on an inner periphery thereof. The engaging ring 21 is disposed in the transmission groove 12 of the housing 10. The pivoting seat 22 includes a pivot shaft 221 at an end thereof. The two planetary gears 23 are disposed on the pivoting seat 22 and protrude from the outer periphery of the pivoting seat 22. The pivoting seat 22 is disposed in the engaging ring 21 in such a manner that the pivot shaft 221 penetrates the transmission groove 12, and the respective planetary gears 23 are engaged with the inner annular tooth portion 211 of the engaging ring 21. The connecting shaft 24 includes a cylindrical tooth portion 241 at a first end thereof, and a connecting portion 242 at a second end thereof. The cylindrical tooth portion 241 of the connecting shaft 24 is inserted into the pivoting seat 22 and engaged with the planetary gears 23. The pivot shaft 221 of the pivoting seat 22 is provided with one bearing 25, and both ends of the connecting shaft 24 are provided with one bearing 25, so that when the connecting shaft 24 is driven to rotate, the two planetary gears 23 can slow down the connecting shaft 24 by cooperating with the engaging ring 21.

The first cover 30 is screwed on the housing 10 opposite the transmission groove 12. The first cover 30 covers the transmission mechanism 20. The first cover 30 further includes a through hole 31 for penetration of the connecting portion 242 of the connecting shaft 24. The connecting shaft 24 is connected to a power tool after penetrating the through hole 31 of the first cover 30.

The linkage mechanism 40 includes a rotary disc 41, a slide block 42 and a moving shaft 43. The rotary disc 41 includes a central through hole 411 for insertion of the pivot shaft 221 which penetrates the transmission groove 12. The rotary disc 41 is further eccentrically provided with a protruding cylinder 412. The slide block 42 is slidably disposed between the two guiding portions 15 and defined with a sliding slot 421. The protruding cylinder 412 is inserted through the sliding slot 421. The slide block 42 is further defined with an assembling groove 422, and the moving shaft 43 is assembled in the assembling groove 422 in such a manner that an extending direction of the moving shaft 43 is vertical to an extending direction of the sliding slot 421 of the slide block 42. The moving shaft 43 is then inserted into the grease passage 131 of the housing 10. By such arrangements, when the pivot shaft 221 rotates, the rotary disc 41 will be driven to rotate, and then the protruding cylinder 412 of the rotary disc 41 will drive the slide block 42 to linearly slide between the two guiding portions 15, and finally the moving shaft 43 will move linearly in the grease passage 131 to squeeze the grease out.

The second cover 50 covers the linkage mechanism 40 and is screwed on the housing 10. The second cover 50 is defined with a notch 51 for evasion of the protruding cylinder 412 of the linkage mechanism 40.

The pressure-relief device 60 includes a valve member 61, a spring 62 and a cover member 63. The valve member 61 includes a conical stopping end 611. The stopping end 611 is inserted into the grease-passage port 141 of the valve port 14 of the housing 10, the spring 62 is mounted on the valve member 61, and the cover member 63 seals the valve port 14 of the housing 10, such that the spring 62 is normally pressed against the valve member 61 to make the stopping end 611 of the valve member 61 seal grease-passage port 141.

The abovementioned is the structural relation of the components of the grease gun with a pressure-relief device in accordance with the present invention. The cartridge accommodation groove 11 of the housing 10 is provided for accommodation of a grease cartridge A, and the connecting portion 242 of the connecting shaft 24 extending out of the first cover 30 is connected to a power tool B. When the power tool B drives the connecting shaft 24, the cylindrical tooth portion 241 of the connecting shaft 24 will drive the planetary gears 23 to move the pivoting seat 22 to rotate in the engaging ring 21. The planetary gears 23 cooperate with the engaging ring 21 to offer the deceleration function, The pivot shaft 221 of the pivoting seat 22 which penetrates the transmission groove 12 will drive the rotary disc 41 to rotate, and then the protruding cylinder 412 on the rotary disc 41 will drive the slide block 42 to slide linearly between the two guiding portions 15 of the housing 10, meanwhile, the grease in the grease cartridge A will flow into the grease passage 131 through the communication hole 132, and the moving shaft 43 of the slide block 42 will slide linearly into the grease passage 131 of the housing 10 to squeeze the grease out from the grease cartridge A.

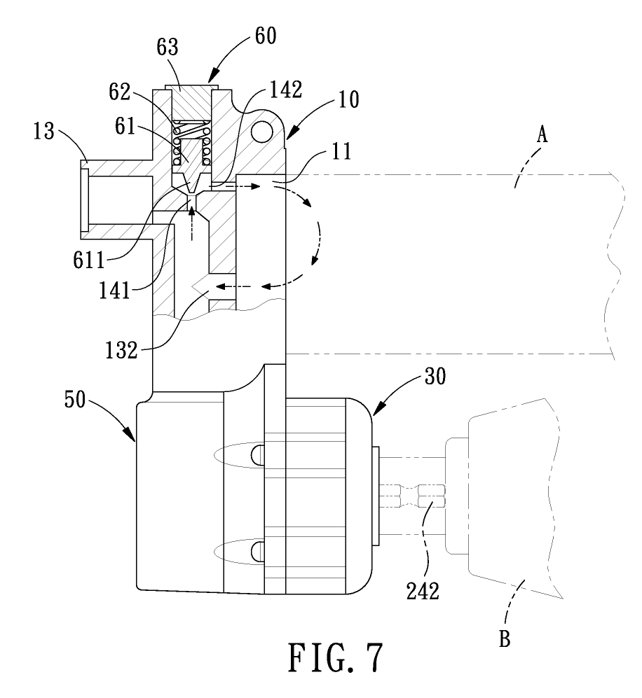

When a power tool B with larger driving force is used, the larger driving force will squeeze out excessive grease or squeeze out the grease excessively quickly, at this moment, the grease which is squeezed out by the large driving force will dash against the valve member 61 of the pressure-relief device 60, and then the valve member 61 will push against the spring 64 to compress it toward the cover member 63, and the stopping end 611 of the valve member 61 will correspondingly move away from the grease-passage port 141 to allow the grease-passage port 141 and the cartridge port 142 to communicate with each other, as shown in FIG. 7, so that the grease which dashes against the pressure-relief device 60 will flow back into the grease cartridge A through the grease-passage port 141 and the cartridge port 142. By such arrangements, the pressure which makes the inner parts of the housing 10 to be dashed can be controlled, which can avoid the damage to the inner parts of the housing 10, extending the service life.

While we have shown and described various embodiments in accordance with the present invention, it is clear to those skilled in the art that further embodiments may be made without departing from the scope of the present invention.

What is claimed is:

1. A grease gun with a pressure-relief device comprising:
a housing being defined in a first end thereof with a cartridge accommodation groove for accommodation of a grease cartridge, a connecting portion of a connecting shaft of a transmission mechanism protruding from a second end of the housing for connection to a power tool, the housing being further provided with a grease outlet opposite cartridge accommodation groove, the grease outlet being defined with a grease passage, the grease passage being connected to the cartridge accommodation groove through a communication hole, a valve port being vertically connected to the grease passage in the grease outlet through a grease-passage port, the valve port being further defined with a cartridge port connected to the cartridge accommodation groove; and
a pressure-relief device including a valve member, a spring and a cover member, the valve member including a conical stopping end, the stopping end being inserted into the grease-passage port of the valve port of the housing, the spring being mounted on the valve member, the cover member sealing the valve port of the housing, the spring being normally pressed against the valve member, the stopping end of the valve member sealing the grease-passage port, when being pressed, the valve member will compress the spring toward the cover member to allow the grease-passage port and the cartridge port to communicate with each other;
when grease in the grease cartridge is squeezed out by an excessively large force, the grease will dash against the valve member of the pressure-relief device, and then the valve member will push against the spring to compress it toward the cover member, at this moment, the stopping end of the valve member will move away from the grease-passage port to allow the grease-passage port and the cartridge port to communicate with each other, and finally, the grease which dashes against the pressure-relief device will flow back into the grease cartridge through the grease-passage port and the cartridge port, such that a pressure applied onto inner parts of the housing is controlled.

2. The grease gun with a pressure-relief device as claimed in claim 1, wherein the housing is further defined with a transmission groove in a second end thereof, the housing is integrally formed with two guiding portions opposite the transmission groove, the two guiding portions have two opposite planar surfaces, a transmission mechanism is disposed in the transmission groove, and a pivot shaft penetrates the transmission groove and drives a linkage mechanism to linearly move between the two guiding portions.

3. The grease gun with a pressure-relief device as claimed in claim 2, wherein the linkage mechanism includes a rotary disc, a slide block and a moving shaft, the rotary disc includes a central through hole for insertion of the pivot shaft which penetrates the transmission groove, the rotary disc is further eccentrically provided with a protruding cylinder, the slide block is slidably disposed between the two guiding portions and defined with a sliding slot, the protruding cylinder is inserted through the sliding slot, the slide block is further defined with an assembling groove, and the moving shaft is assembled in the assembling groove in such a manner that an extending direction of the moving shaft is vertical to an extending direction of the sliding slot of the slide block, the moving shaft is then inserted into the grease passage of the housing, by such arrangements, when the pivot shaft rotates, the rotary disc will be driven to rotate, and then the protruding cylinder of the rotary disc will drive the slide block to linearly slide between the two guiding portions, and finally the moving shaft will move linearly in the grease passage to squeeze the grease out.

4. The grease gun with a pressure-relief device as claimed in claim 3, wherein the transmission mechanism further includes an engaging ring, a pivoting seat, and two planetary gears, the engaging ring includes an inner annular tooth portion on an inner periphery thereof, the engaging ring is disposed in the transmission groove of the housing, the pivoting seat includes the pivot shaft at an end thereof, the two planetary gears are disposed on the pivoting seat and protrude from an outer periphery of the pivoting seat, the pivoting seat is disposed in the engaging ring in such a manner that the pivot shaft penetrates the transmission groove, and the respective planetary gears are engaged with the inner annular tooth portion of the engaging ring, the connecting shaft includes a cylindrical tooth portion at a first end thereof, and a connecting portion at a second end thereof, the cylindrical tooth portion of the connecting shaft is inserted into the pivoting seat and engaged with the planetary gears.

5. The grease gun with a pressure-relief device as claimed in claim 4, wherein the transmission mechanism further includes plural bearings, the pivot shaft of the pivoting seat is provided with one bearing, and both ends of the connecting shaft are provided with one bearing.

6. The grease gun with a pressure-relief device as claimed in claim 4 further comprising a first cover, the first cover being screwed on the housing opposite the transmission groove, the first cover covering the transmission mechanism, the first cover further including a through hole for penetration of the connecting portion of the connecting shaft.

7. The grease gun with a pressure-relief device as claimed in claim 3 further comprising a second cover, the second cover covering the linkage mechanism and being screwed on the housing, the second cover being defined with a notch for evasion of the protruding cylinder of the linkage mechanism.
